(19) United States
(12) Patent Application Publication
(10) Pub. No.: US 2020/0135350 A1
(43) Pub. Date: Apr. 30, 2020

(54) Water Vapor Quantification Methodology During Drying of Spent Nuclear Fuel

(71) Applicant: University of South Carolina, Columbia, SC (US)

(72) Inventors: Tanvir Farouk, Irmo, SC (US); Malik Tahiyat, Columbia, SC (US); Travis W. Knight, Blythewood, SC (US)

(73) Assignee: University of South Carolina, Columbia, SC (US)

(21) Appl. No.: 16/550,419

(22) Filed: Aug. 26, 2019

Related U.S. Application Data
(60) Provisional application No. 62/750,324, filed on Oct. 25, 2018.

(51) Int. Cl. G21C 17/06; G21F 9/28; H05H 1/00; G21C 13/02

(52) U.S. Cl. CPC G21C 17/06; G21C 13/02; H05H 1/0037; G21F 9/28

(57) ABSTRACT

Methods and devices for detecting and quantifying water vapor concentration in spent nuclear fuel rods undergoing drying processes for safe storage purposes.

### BACKGROUND OF THE INVENTION

This invention was made with government support under DE-NE0008273 awarded by the DOE Office of Nuclear Energy's Nuclear Energy University Programs. The government has certain rights in the invention.

### 1) Field of the Invention

The present invention relates to a methods and devices for detecting and quantifying water vapor concentration in spent nuclear fuel rods undergoing drying processes for safe storage purposes.

### 2) Description of Related Art

Spent fuel rods from nuclear reactors are initially kept in spent fuel pools to allow radioactivity to die away to levels that these rods can be stored in a dry cask. After being transferred to dry cask storage, the rods are sealed in a canister shrouded in inert gas and protected by an overpack of concrete that also serves as a radiation shield.

The purpose of drying is to remove the water left in the canister and fuel assemblies to ensure the long term integrity and retrievability of the spent fuel assemblies. Drying is performed as a vacuum drying process or a forced gas recirculation process. Vacuum drying with pressure hold points, that indirectly relate to the available water vapor content in the fuel canister, is the most common industry practice to certify the “dryness” level of the system.

In-line moisture content detection and quantification in fuel canisters is generally limited. Hindrances include: (1) conventional humidity sensors posing several limitations such as low sensitivity to moisture detection; (2) inconsistency in ascertaining the end point of the drying process; (3) quantifying the absolute ‘mass’ of water leaving the system. Therefore, effective drying and determination methods are a topic of industry and research interest.

Among the different non-intrusive techniques of water vapor detection and quantification, non-thermal plasma discharge bears the potential of overcoming many of the above systems' limitations. It has been demonstrated that an inductively coupled plasma (ICP) together with optical emission spectroscopy (OES) can be employed in situ to detect moisture in a lyophilization chamber for freeze-drying process. A radio frequency driven ICP plasma generated in a quartz glass tube under low-pressure condition provided the necessary emission bands of nitrogen and water for detection purpose. The procedure was localized and offered more of a qualitative determination (i.e. information of water presence only) of the critical stages in a freeze-drying cycle. Multipoint near-infrared (NIR) spectroscopy has also been applied for in-line moisture content quantification during freeze-drying process. Three non-contact diffuse reflectance NIR probe heads, placed in the freeze-drying apparatus, were able to detect the unequal sublimation rates. However, in-line moisture content quantification was only reliable toward the end of the freezing process.

Andrawes, see F. F. Andrawes Analytical Chemistry 55, (1983), proposed a methodology for determining trace water contents in gaseous mixtures, utilizing a gas chromatography technique together with helium ionization. The helium detector was able to provide responses to all trace compounds with an ionization potential below 19.8 eV and thus, detected water vapor, which has an ionization potential of 12.8 eV, with good sensitivity. The lowest detection limit was found to be 2 ppm. Hanamura et al., see B. K. S. Hanamura, J. D. Winefordner Analytical Chemistry 57, (1985), employed a helium microwave plasma emission spectrometry to determine trace amounts of adsorbed and bound water in solid samples in which, peak areas of atomic oxygen (O) and hydrogen (H) were used to determine the water concentration.

Radical species generated as a result of plasma interaction with water vapor has been a topic of great interest as well—mostly driven by biomedical applications. Yonemori et al., see, Yonemori, Y. Nakagawa, R. Ono and T. Oda Journal of Physics D: Applied Physics 45, (2012), employed laser-induced fluorescence (LIF) techniques to determine the OH concentration in an atmospheric pressure helium plasma jet where ambient humid air is entrained in the afterglow. Others have conducted OH planar laser-induced fluorescence (PLIF) measurements to quantify the temporal evolution of OH density in a nanosecond repetitively pulsed spark discharge operating in pure water vapor. In a more recent study, see Verreycken, N. Sadeghi and P. Bruggeman Plasma Sources Science and Technology 23, (2014), time-resolved OH density measurement was conducted in a nanosecond pulsed filamentary discharge in an atmospheric pressure He—H₂O (0.05%) mixture using the LIF technique to investigate the lifetime of the excited OH states as well as to study the associated kinetics. A detailed global model for the aforementioned He-H₂O plasma system has been proposed to identify the role of water vapor on the dominant reaction pathways contributing to ion generation. The ionization mechanisms elaborated on, however, were the ones chiefly predominant only below 3000 ppm of water vapor loading.

It is an object of the present disclosure to provide a direct current (DC) driven plasma discharge and optical emission spectroscopy for detecting as well as quantifying water vapor in a flowing gas stream under both trace and high-water vapor loading conditions. For the quantification of water content, the system was calibrated extensively and was then employed in a large scale mock nuclear fuel rod assembly drying experiments.

### BRIEF SUMMARY OF THE INVENTION

In one embodiment, a plasma discharge cell water vapor detection system is provided. The system may include an inlet feedthrough, an outlet feedthrough, a plasma cell including at least two electrodes forming an inter-electrode gap, an optical emission spectrometer including at least one optical filter, a chamber containing at least the at least one electrode and the optical emission spectrometer, a cathode, an anode; and at least one flange. Further, the at least one electrode may be formed from copper. Still further the system may include at least two electrodes with an insulation coating on an outer periphery of the at least two electrodes where insulation is excluded at an end of each electrode that forms an inter-electrode gap between the at least two electrodes. Yet again, the chamber may comprise a four-way cross chamber. Further still, the system includes at least one flange that may comprise a visualization port. Further again, the system may be insensitive to any type of radiation effect from a spent nuclear fuel rod. Yet again, the system may be installed in a spent nuclear fuel cask. Yet further, the system has an inter-electrode separation distance the may be increased or decreased.

In an alternative embodiment, a method for quantifying water vapor concentration in a gaseous stream is provided. The method may include forming a negative pressure via a vacuum pump inside a plasma chamber, injecting a sample into a vacuum chamber thereby mixing the sample with a carrier gas, flowing the mixed carrier gas mixed with sample past at least one mass flow controller, initiating and maintaining a plasma discharge, measuring a voltage across the plasma discharge and across a shunt via a cathode ray oscilloscope and a high voltage probe, detecting water vapor concentration via measuring hydrogen emissions undergoing a first series Balmer transition; and quantifying the water vapor concentration in the carrier gas and sample mixture. Further still the carrier gas may be helium. Still yet, Ha emission may be measured. Yet still, the plasma discharge may be operated in normal glow mode so that the plasma discharge maintains a constant electron, ion, and excited state number density value. Further again, the hydrogen emission measure may be Ha at 656.2 nm. Still again, the method may be insensitive to any type of radiation effect from a spent nuclear fuel rod. Yet still, the method may be employed with respect to a spent nuclear fuel cask. Further again, the method may include varying an inter-electrode separation distance.

In a still yet further embodiment, a method for operating a plasma discharge cell water vapor detection system is provided. The method includes ensuring the system and a power supply are properly grounded, activating a vacuum pump on an outlet of the system, opening an inlet valve to let gas into the system apparatus from a sample, adjusting an outlet valve to the vacuum pump until pressure inside the system reaches approximately 3-5 Torr, activating the power supply, increasing discharge voltage until breakdown is achieved, adjusting a discharge current until a sufficiently large negative glow is achieved and peaks of measurable magnitudes appear on an optical emission spectrum, identifying emission peaks via an optical emission spectrum, calculating emission presence, and over a course of operation for the system, ensuring there is no condensation of water inside the system. Further, the method may include adjusting pressure by either further closing the outlet valve or further opening the inlet valve. Again still, the method may include comparing the emission peaks to a water concentration calibration chart. Still further, condensation may be signified by presence of droplets on a viewport.

### BRIEF DESCRIPTION OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1A a schematic of the water detection system with the calibration equipment and associated diagnostics setup of the current disclosure.

FIG. 1B shows a sectional view of a plasma discharge cell of the current disclosure.

FIG. 2 shows peak normalized emission intensity of H_{α} as a function of water mole fraction at an operating pressure of 16.6 Torr and discharge current of 2.0 mA. The H_{α} emission intensity is normalized by [H_{α}+He(3³D)], [H_{α}+He(3¹D)] and [H_{α}+He(3³S)] separately.

FIG. 3 shows peak normalized emission intensity of H_{α} as a function of water mole fraction at an operating pressure of 2.0 Torr and discharge current of 2.0 mA. The H_{α} emission intensity is normalized by [H_{α}+He(3³D)], [H_{α}+He(3¹D)] and [H_{α}+He(3³S)] separately.

FIG. 4 shows peak normalized emission intensity of H_{α} as a function of water mole fraction at an operating pressure of 2.0 Torr for two different discharge currents of 2.5 mA and 5.0 mA.

FIG. 5 shows a diagram illustrating the flow path and components involved in the vacuum drying process in a mock nuclear fuel rod assembly wherein the plasma OES cell is marked.

FIG. 6 shows variation of water concentration as a function of different pressure conditions observed by the fuel casket during the vacuum drying process.

FIG. 7 shows step-by-step instructions for operation of a system of the current disclosure.

It will be understood by those skilled in the art that one or more aspects of this invention can meet certain objectives, while one or more other aspects can meet certain other objectives. Each objective may not apply equally, in all its respects, to every aspect of this invention. As such, the preceding objects can be viewed in the alternative with respect to any one aspect of this invention. These and other objects and features of the invention will become more fully apparent when the following detailed description is read in conjunction with the accompanying figures and examples. However, it is to be understood that both the foregoing summary of the invention and the following detailed description are of a preferred embodiment and not restrictive of the invention or other alternate embodiments of the invention. In particular, while the invention is described herein with reference to a number of specific embodiments, it will be appreciated that the description is illustrative of the invention and is not constructed as limiting of the invention. Various modifications and applications may occur to those who are skilled in the art, without departing from the spirit and the scope of the invention, as described by the appended claims Likewise, other objects, features, benefits and advantages of the present invention will be apparent from this summary and certain embodiments described below, and will be readily apparent to those skilled in the art. Such objects, features, benefits and advantages will be apparent from the above in conjunction with the accompanying examples, data, figures and all reasonable inferences to be drawn therefrom, alone or with consideration of the references incorporated herein.

### DETAILED DESCRIPTION OF A PREFERRED EMBODIMENT

With reference to the drawings, the invention will now be described in more detail. Unless defined otherwise, all technical and scientific terms used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are herein described.

Unless specifically stated, terms and phrases used in this document, and variations thereof, unless otherwise expressly stated, should be construed as open ended as opposed to limiting. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

The current disclosure provides a methodology involving plasma optical emission spectroscopy driven by a direct current plasma source developed to quantify water vapor concentration in a gaseous stream. The setup/method consists of a DC driven low-pressure plasma cell in which, the emission from the plasma discharge is measured by an optical emission spectrometer via an optical probe. Among the different emission profiles, the emission from Hα at 656.2 nm—the first transition in the Balmer series was found to be the most sensitive to the water vapor concentration in the gaseous stream. Experiments were conducted multiple times for each combination of pressure and current to reduce experimental variability. In each experimental run, consistent linear trends of the detection markers with respect to variation in concentration of water were observed. The detection markers were found to have very weak dependence on operating pressure and current. This method has been applied to a vacuum drying process of a mock nuclear fuel assembly to quantify the concentration of water vapor during the drying process.

A plasma based optical emission spectroscopy technique has been developed for detecting and quantifying water vapor concentration in moisture enriched flow conditions. The emission intensity of the hydrogen α-Balmer line (Hα) was found to be the most sensitive signal for this purpose of detecting water vapor concentration as low as ˜2 ppm. The normalized fractional intensity of Ha was identified to have a strong linear dependency on the water vapor content in the gaseous stream and therefore was selected as a detection and quantification marker. It was further found that the normalized intensity was independent of the plasma discharge current conditions in the “normal glow” regime of operation of the discharge as well as the vacuum operating pressure for this system. This confirmed the versatility of the emission intensity signal over the wide range of parametric space. The proposed methodology has been applied to characterize outflow gases from the drying of a mock nuclear used fuel assembly. Based on the experimental results, it has been observed that the OES can successfully determine the level of dryness of the system by portraying the composition of the gaseous mixture with decreasing pressure.

The current disclosure has wide range of operation limit. It can detect water content from ˜2 ppm to almost 100% concentration. This emission based detection is insensitive to any type of radiation effect from the spent nuclear fuel rod. The device and methodology also has extremely high sensitivity. The system is modular, easily manufactured and can be readily installed in spent nuclear fuel casks for continuous monitoring of water content. A continuous monitor can also promote safety by having warning signs associated to catastrophic failure of the system due to free hydrogen available in the system due to the residual water and water vapor.

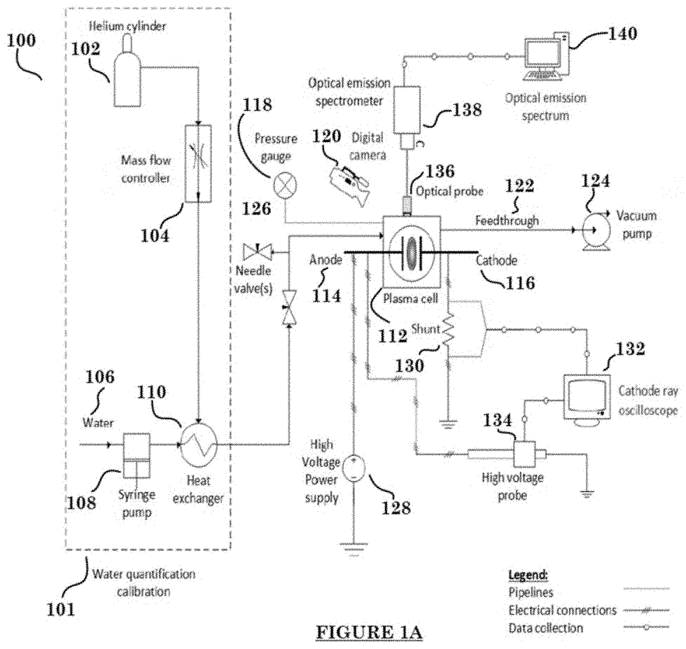

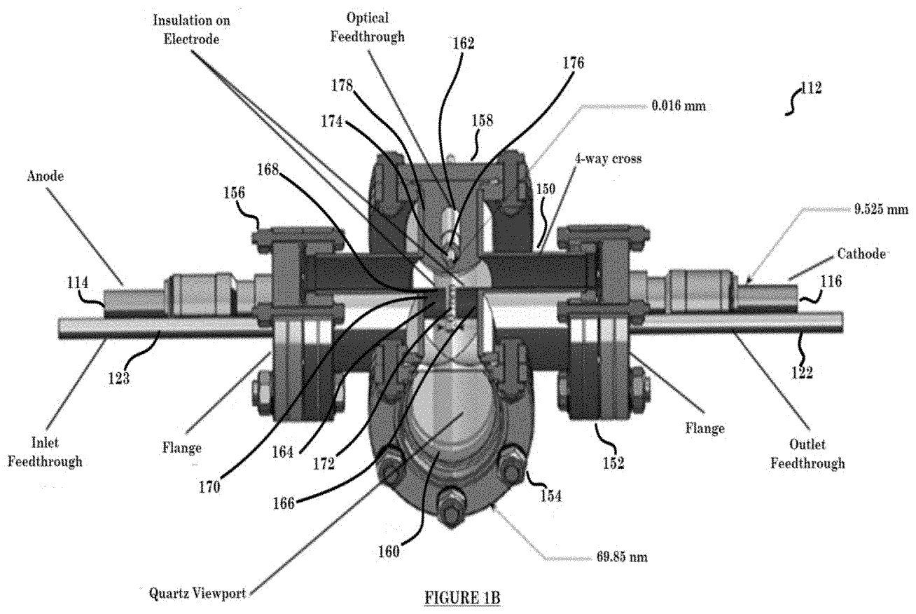

The schematic of one embodiment of a plasma discharge cell setup for water detection together with the ancillaries that include the calibration unit and the diagnostics and measurement tools of the current disclosure is shown as FIG. 1A. FIG. 1A shows one embodiment of a system 100 of the current disclosure. In one embodiment, system 100 may include a water quantification calibration system 101, which includes a helium source 102, which in one embodiment may be a helium cylinder, in association with a mass flow controller 104, a water source 106, a syringe pump 108, and a heat exchanger 110. System 100 may also include a plasma cell 112, anode 114, cathode 116, a pressure gauge 118, a digital camera 120 for viewing the system operation in real time as well as to help calibrate and monitor the system, an outlet feedthrough 122 to a vacuum pump 124, an inlet feedthrough 123 (see FIG. 1B), at least one needle valve 126, a high voltage power supply 128, a shunt 130 in association with a cathode ray oscilloscope 132 as known to those of skill in the art, a high voltage probe 134, an optical probe 136, an optical emission spectrometer 138, and an optical emission spectrum analyzer 140, which may comprise a computer or other analysis device.

Plasma chamber 112 may consist of two solid cylindrical copper electrodes 164 and 166, each with a diameter of 9.525 mm. A thin 0.34 mm of insulation coating 168 may be provided on the outer periphery 170 of the electrodes to prevent discharge initiation and formation on the cell wall and to further ensure that the discharge is confined within the inter-electrode gap 172, providing the perfect/optimum field of view for the optical probe 174 to record the emission intensity. The inter-electrode gap 172, or gap separation, is typically maintained at a spacing of 4 mm. The emission from the plasma discharge is acquired by an optical emission spectrometer 138, in one embodiment this may be an OCEAN OPTICS HR 4000CG-UV-NIR, via an optical fiber 176, for instance QP450-2-XSR, and the emission spectrum is observed and recorded using a spectroscopy software, for instance OCEANVIEW from Ocean Optics, on an optical emission spectrum analyzer 140. Electrodes 164 and 166 and optical probe 174 are housed inside a four-way cross tee 150 having 69.85 mm flange diameter. Second or front flange 154 may be fitted with a viewport 160, for purposes of example only a fused silica glass window for visualization purposes. One of the electrodes may be connected to a bellow arrangement (not shown) to vary the inter-electrode separation 172 if necessary.

A varying inter-electrode separation distance provides the capability of initiating a plasma over a wide range of pressures by maintaining a constant pressure×distance (pd) value. FIG. 1B shows a sectional view of the plasma discharge cell 112. In one embodiment, plasma cell 112 may include a 4-way cross or tee configuration 150 formed from a first flange 152, second flange 154, third flange 156, and fourth flange 158. Second flange 154 may include a viewport 160, which may be quartz or other suitable material. Plasma cell 112 may also include a cathode 116, an anode 114 an outlet feedthrough 122, inlet feedthrough 123, an optical feedthrough 162, first and second electrodes 164 and 166, as well as insulation 168 on each electrode.

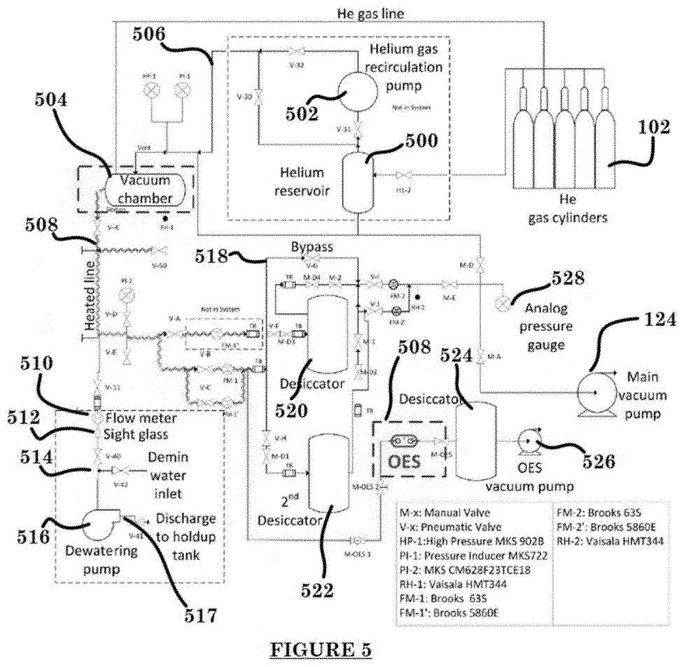

The pressure inside the plasma chamber may be varied by means of a vacuum pump 124. For calibration of water vapor, see FIG. 5, the carrier gas may be contained in a reservoir 500 connected to a recirculation pump 502, then mixed with water vapor and injected into a vacuum chamber 504 as a result of the negative pressure differential created by vacuum pump 124 to eliminate the possibility of gas accumulation in piping network 506. Two calibrated mass flow controllers (MFCs) 104, which may be MFCs from MKS Instruments, each specified for different flow ranges, may be employed for accurate varying of the gas mixture composition for the calibration of the emission spectrum. The respective operating ranges of the MFCs 104 for helium gas are 0-200 standard cubic centimeters per minute (sccm) and 0-500 sccm. For both MFCs 104, the control range is from 2 to 100% of full scale (F.S.) with an accuracy of ±1% of F.S. and repeatability of ±0.2% of F.S. measured with a digital pressure gauge 118, such as a Teledyne Hastings 760s, with a Spellman power supply unit 128 and a ballast of 10kΩ. The voltage across the plasma discharge and across the shunt 130 is measured with a cathode ray oscilloscope 132, such as an Agilent Technologies INFINIIVISION MSO7054B, and a high voltage probe 134, such as a North Star high voltage PVM-4. The emission from the plasma discharge is acquired by an optical emission spectrometer 138, such as an OCEAN OPTICS HR 4000CG-UV-NIR, via an optical fiber 126, such as QP450-2-XSR, and the emission spectrum is observed and recorded using an optical emission spectrum analyzer 140 using spectroscopy software, such as OCEANVIEW from Ocean Optics.

For detecting water vapor concentration, the emission from H_{α} at 656.2 nm was employed. The H_{α} emission is the red visible spectral line generated by a hydrogen atom when an electron falls from the third lowest to second lowest energy level; this is the first transition in the Balmer series. The H_{α} is formed by the dissociation of water vapor to OH and H, which undergoes further electronic excitation via electron impact reactions. The emission from H_{α} was chosen for detection purpose because of its very high sensitivity. The experiments conducted to support of the current disclosure showed that even at a concentration of 2 ppm of water vapor, an emission from H_{α} was observed. The emission intensity of H_{α} was directly related to the water concentration level and thus was acquired for a range of water vapor concentration(s). In the calibration experiments, the water vapor concentration was systematically increased in the gas mixture by injecting a higher amount of water vapor into the helium stream.

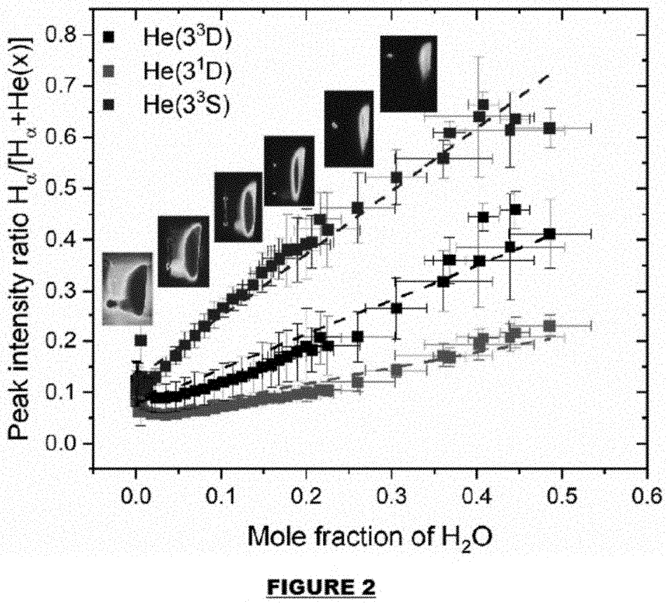

FIG. 2 shows the H_{α} intensity normalized by the summation of intensities of H_{α} and each of the three different He excited states [He(3³D) 587.6 nm, He(3¹D) 667.8 nm and He(3³S) 706.5 nm] separately for a plasma discharge operating at 16.6 Torr pressure and having 2.0 mA discharge current. Four independent experiments were conducted and the error bars represent the standard deviation among the four experimental data sets. For sensitivity purpose, the emissions from the three different excited states of helium were investigated. It can be seen that all three normalized H_{α} intensity signals increase linearly with increasing water vapor content. This suggests that the normalized H_{α} intensity can be used as a marker for water vapor detection and quantification.

Despite the linear trend in all three of the emission intensity signals, it is apparent that as the water to helium flow ratio is increased beyond 0.5 the uncertainty in the measurements increases. This can be explained as follows: the plasma cell was operated at room temperature, which had been approximately at 290 K; along the vapor-liquid interface line in the phase diagram of water, 290 K corresponds to 15 Torr, which is lower than the operating pressure pertaining to FIG. 2; thus, it is reasonable to assume that at higher partial pressure of water vapor, water may condense inside the plasma cell, resulting in nonlinearity in measurements. Exemplar false-colored images of the plasma discharge are also presented in FIG. 2 as insets. It is apparent that with an increase in the water vapor content, the discharge radially constricts and at the same time its emission intensity decreases. The lower diffusivity of water vapor is primarily responsible for the observed overall radial constriction and hence the reduction in intensity. However, the emission intensity of H_{α} decreases at a lesser gradient than that of excited states of helium. Therefore, despite the overall intensity decreasing, the fractional intensity ratio of H_{α} to that of [H_{α}+He(x)] has a positive slope. The radial constriction of the discharge also increases the current density for the same discharge current. It is observed that for a constant discharge current in the system the discharge constricted almost by a factor of ˜4.0 for the entire range of moisture loading.

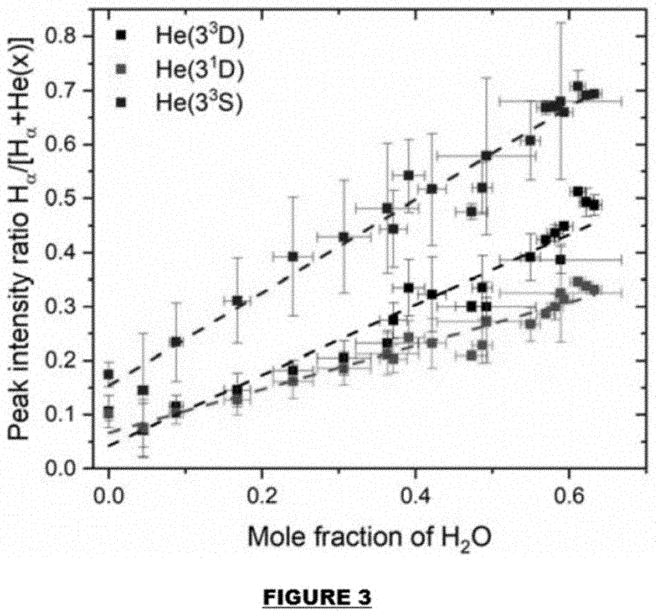

To increase the maximum limit of water loading without possible condensation taking place, additional experiments were conducted at even lower pressure. These experiments were conducted at 2.0 Torr but for the same discharge current of 2.0 mA. FIG. 3 summarizes the normalized H_{α} emission intensity for different water vapor fraction for those experiments. Similar to the 16.6 Torr experiments, four separate sets of experiments were conducted and the error bars represent the standard deviation. At 2 Torr, the emissions from the helium excited states are slightly different but a strong linear correlation is maintained nonetheless. At higher water loading the emission intensity of He(3³S) at 706.5 nm was found to reduce significantly but the He (3¹D) and He (3³D) emission remain responsive over entire water vapor range of interest. This may be attributed to the wavelengths of these signals pertaining to similar electron transitional state (1s.2p-1s.3d). The emission of He(3³S) at 706.5 nm is related to a smaller electron transition (1s.2p-1s.3s) therefore as the helium concentration reduces in the gas mixture, the He(3³S) intensity decreases significantly faster resulting in a larger slope of H_{α}/[H_{α}+He(3³S)] as a function of the water concentration in the system. The error bars associated with Hα/[H_{α}+He(3³S)] are also significantly larger than the other two signals, which is strictly due to the larger variation in He(3³S) emission. Therefore, H_{α}/[H_{α}+He(3¹D)] and H_{α}/[Hₐ+He(3³D)] signals are the ones deemed more reliable as water detection markers. It should be noted that at the low range of water mole fraction i.e. 0-0.05, a slight nonlinearity in the emission intensity is observed at both 2 and 16.6 Torr, see FIGS. 2 and 3. This nonlinearity was observed consistently. A definitive understanding of the cause of this non-linearity is still being pursued at this stage.

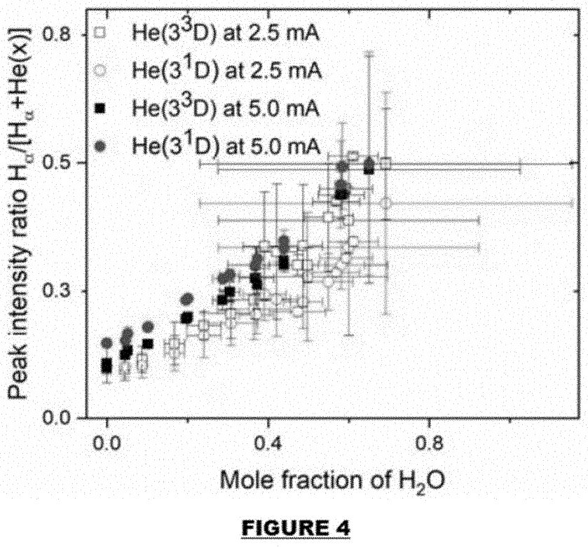

To determine if the detection markers are insensitive to discharge current conditions, a range of experiments were conducted for different discharge currents at the same operating pressures. It was found that the normalized intensity signals of H_{α}/[H_{α}+He(3³D)] at different discharge currents collapsed on top of each other, see FIG. 4, and still maintains a linear trend. Since the plasma discharge that is used as the source for the different excited states is operated in the “normal glow” mode, an increase in the current does not increase the current density but the discharge size only—an increase in the discharge cross-sectional area.

In the “normal glow” regime of operation, the discharge maintains a constant electron, ions and excited states number density value, see T. Farouk, B. Farouk, D. Staack, A. Gutsol and A. Fridman Plasma Sources Science and Technology 15, (2006)., which is hereby incorporated by reference. A larger cross-sectional area/volume of the discharge results in a higher spatially averaged emission intensity acquired by optical probe 136 but the relative increase in the intensity of H_{α} with respect to that of each of He(3³D), He(3¹D) and He(3³S) is similar. As a consequence, the normalized intensity remains insensitive to the discharge current. This holds true for the “normal glow” regime of operation only.

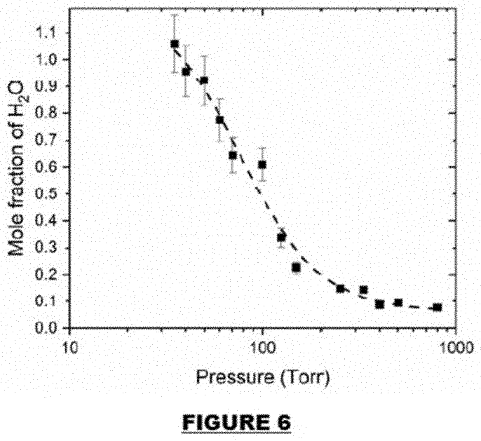

Plasma discharge cell 112 and the associated diagnostics may be connected to a mock nuclear fuel rod assembly to acquire and detect real-time gas composition data, representative of a vacuum drying process. A schematic of the large-scale experiment with a plasma OES cell connected to it is shown in FIG. 5. The fuel rod assembly cask, no shown, which has a volume of 484 liters is wetted with a known amount of water. The cask is then purged and pressurized to one atmosphere with helium and then progressively vacuumed in multiple stages to promote the drying process. A small stream of outflow gas from the cask is bled off into the OES cell 508 maintained at a pressure of 2 Torr, see FIG. 6 for the emission intensity which shows the water vapor concentration as a function of vacuum pressure in the mock fuel rod assembly. The water concentration was determined from the extensive database of the water vapor detection marker for ranges of current and pressure showing the variation of H_{α} to [H_{α}+He(3³D)]. As FIG. 5 illustrates, the system may also include heated lines 508, flow meter 510, sight glass 512, water inlet 514, discharge to holdup tank 517, bypass 518, first desiccator 520, second desiccator 522, an OES desiccator 524, an OES vacuum pump 526.

It is observed that up to 200 Torr, the concentration of water vapor remains approximately the same as that in atmospheric condition but starts to rise exponentially when the pressure inside the chamber drops below 200 Torr. The plots also show that when the chamber has been exposed to a pressure of 30 Torr, the resulting pressure is predominantly the partial pressure of water vapor. This was further reconfirmed by measurements by relative humidity sensors, not shown. It is to be noted that even though the existing signal marker database, see FIGS. 2 and 3, account for a maximum of 0.65 mole fraction of water, this database has been extrapolated to quantify mole fraction as high as 1.0. The validity for this extrapolation stems from the strong linear correlation between the normalized ratio of the signal intensity and the concentration of water.

In summary, a plasma based optical emission spectroscopy technique has been developed for detecting and quantifying water vapor concentration in moisture enriched flow conditions. The emission intensity of the hydrogen α-Balmer line (H_{α}) was found to be the most sensitive signal for this purpose of detecting water vapor concentration as low as ˜2 ppm. The normalized fractional intensity of H_{α} was identified to have a strong linear dependency on the water vapor content in the gaseous stream and therefore was selected as a detection and quantification marker. It was further found that the normalized intensity was independent of the plasma discharge current conditions in the “normal glow” regime of operation of the discharge as well as the vacuum operating pressure for this system. This confirmed the versatility of the emission intensity signal over the wide range of parametric space. The proposed methodology has been applied to characterize outflow gases from the drying of a mock nuclear used fuel assembly. Based on the experimental results, it has been observed that the OES can successfully determine the level of dryness of the system by portraying the composition of the gaseous mixture with decreasing pressure.

In a further embodiment, a methodology is provided involving plasma optical emission spectroscopy driven by a direct current (dc) plasma source developed to quantify water vapor concentration in a gaseous stream. The experimental setup consists of a dc driven low-pressure plasma cell in which the emission from the plasma discharge is measured by using an optical emission spectrometer 138. The emission from H at 656.2 nm—the first transition in the Balmer series, was found to be the most sensitive to the water vapor concentration in the gas stream. Consistent linear trends of the emission signals with respect to variation in concentration of water are observed for multiple combinations of operating parameters. This method has been applied to a vacuum drying process of a mock nuclear fuel assembly to quantify the concentration of water vapor during the drying process.

The schematic representation of the proposed plasma discharge cell setup for water vapor detection together with the ancillaries, i.e., calibration unit, diagnostics, and measurement tools, is presented in FIG. 1A. The plasma cell, see FIG. 1B, consists of two solid cylindrical copper electrodes 164 and 166. A thin 0.34 mm insulation coating 168 is provided on the outer periphery 170 of electrodes 164 and 166 to prevent discharge initiation and formation on cell wall 178 and to further ensure that the discharge forms within inter-electrode gap 172, providing the perfect/optimum view angle for optical probe 174 for recording the emission intensity.

Inter-electrode gap/separation 172 is typically maintained at 4 mm. The emission from the plasma discharge is acquired by using an optical emission spectrometer 138, for example Ocean Optics HR 4000CG-UV-NIR, via an optical fiber 176, and the emission spectrum is acquired using the “Oceanview” spectroscopy software via an optical emission spectrum analyzer 140.

Electrodes 164 and 166 and optical probe 174 may be housed inside a four-way stainless steel cross chamber 150. Second flange 154, facing the discharge, is fitted with a viewport 160, which may be fused silica glass, for visualization purposes. The pressure inside the plasma chamber is varied by means of a two-stage mechanical vacuum pump 124 and may be measured with a digital pressure gauge 118. For calibration, the carrier helium gas (Praxair UHP 5.0) may be mixed with water vapor and then injected into vacuum chamber 504 as a result of the negative pressure differential created by the vacuum to eliminate the possibility of gas/water vapor accumulation in piping network 506. The liquid water amount is regulated by using a programmable syringe pump 108, which injects water directly into the co-current heat exchanger 110 where it undergoes flash vaporization and simultaneously mixes with the helium gas producing a gaseous helium/water mixture of known composition.

Two calibrated mass flow controllers (MFCs) 104, one from MKS Instruments (0-500 SCCM) and the other from Coastal Instruments (0-200 SCCM), were employed independently for varying mass flow rate of helium over two ranges.

The plasma discharge is initiated and maintained via a Spellman (SL60P300) power supply unit 128. The voltage across the plasma discharge and that across shunt 130 for quantifying the discharge current are both measured with a cathode ray oscilloscope 132 and a high voltage probe 134.

For detecting water vapor concentration, the emission from H at 656.2 nm was employed. The H emission is the red visible spectral line generated by a hydrogen atom when an electron falls from the third lowest to the second lowest energy level; this is the first transition in the Balmer series. The H is formed by the dissociation of water vapor to OH and H which undergoes further electronic excitation via electron impact reactions. The emission from H was chosen for water vapor detection purpose because of its very high sensitivity. The current disclosure shows that even at a concentration of 2 ppm of water vapor, an emission from H was observed. The emission intensity of H was directly related to the water concentration level and thus was acquired for a range of water vapor concentration(s). In the calibration experiments, the water vapor concentration was systematically increased in the gas mixture by injecting a higher amount of water vapor into the helium stream.

FIG. 2 shows the H intensity normalized by the intensity of three different He excited states [He(33 D) 587.6 nm, He(31 D) 667.8 nm, and He(33 S) 706.5 nm] separately for a plasma discharge operating at 16.6 Torr pressure and having 2.0 mA discharge current. Four independent experiments were conducted, and the error bars represent the standard deviation among the four experimental data set(s). For sensitivity purpose, the emissions from the three different excited states of helium were investigated.

It can be seen that all three normalized H intensity signals increase linearly with increasing water vapor content. This suggests that the normalized H intensity can be used as a marker for water vapor detection and quantification. Despite the linear trend in all three of the emission intensity signals, it is apparent that as the water mole fraction is increased beyond 0.5 the uncertainty in the measurements increases. This is due to the fact that at high water vapor loading, there is the possibility of condensation taking place inside plasma cell 112. It should be noted that a slight nonlinearity in the emission is observed for the low water mole fraction range (i.e., 0-0.025). Presumably, this is related to the heavy particle reactions between helium and water (e.g., Penning ionization and charge transfer). A definitive understanding of this behavior is still being pursued at this stage. Exemplar false colored images of the plasma discharge are also presented in FIG. 2 as insets.

It is apparent that with an increase in the water vapor content, the discharge radially constricts and its emission intensity decreases owing to both transport and electronegative behavior of water. Introduction of water in plasma reduces the electron density via attachment reactions which also act as an energy sink and reduce the electron temperature, leading to reduced emission. In addition, compared to helium, water has lower diffusivity, which contributes to the observed constriction as well. However, the emission intensity of H decreases at a lesser gradient than that of excited states of helium, thus rendering the fractional intensity ratio of H to that of [H+He(x)] to attain a positive slope. The radial constriction of the discharge also increases the current density for the same discharge current. It is observed that for a constant discharge current the discharge constricted almost by a factor of 4.0 for the entire range of moisture loading. To increase the maximum limit of water loading without possible condensation taking place, additional experiments were conducted at 2 Torr for 2.0 mA discharge current. The water vapor mole fraction was increased up to 0.65, and similar linear trends of the emission intensity ratios were observed.

To determine if the emission signals have similar linear trends for different discharge parameters, a range of experiments were conducted for different discharge currents and operating pressures. It was found that the normalized intensity signals of H/[H+He(33 D)] at different discharge parameters collapsed on top of each other (not shown here) and still maintained a linear trend. Since the plasma discharge that is used as the source for the different excited states is operated in the “normal glow” mode, an increase in the current does not increase the current density but only the discharge cross-sectional area. This is because, in the “normal glow” regime of operation, the discharge maintains a constant electron, ion, and excited state number density value.

A larger cross-sectional area/volume of the discharge results in a higher spatially averaged emission intensity acquired by using the optical probe, but the relative increase in the intensity of H with respect to that of each of He(33 D), He(31 D), and He(33 S) is similar. Consequently, the normalized intensity still maintained a linear trend as a function of the water content for the different operating pressures and discharge currents.

The plasma discharge cell and the associated diagnostics are connected to a mock nuclear fuel rod assembly to acquire and detect real-time gas composition data, representative of a vacuum drying process, see FIG. 5. Details of the mock nuclear fuel rod drying experiment are provided in T. W. Knight, J. Khan, T. Farouk, and J. Tulenko, in Proceedings of International High-Level Radioactive Waste Management Conference (American Nuclear Society, 2017), which is hereby incorporated by reference. The fuel rod assembly cask is wetted with a known amount of water. The cask is then purged and pressurized to 1 atm with helium and then progressively vacuumed in multiple stages to promote the drying process. A small stream of outflow gas from the cask is bled off into the OES cell, maintained at a pressure of 2 Torr in which the emission intensity is measured.

FIG. 6 shows water vapor concentration as a function of vacuum pressure in the mock fuel rod assembly. The water concentration was determined from the extensive database of the water vapor emission signals for ranges of current and pressure showing the variation of H to [H+He(33 D)]. It is observed that up to 200 Torr, the concentration of water vapor remains mostly unchanged but increases exponentially thereafter. The plot also shows that below 30 Torr, the resulting pressure is predominantly the partial pressure of water vapor, reconfirmed by measurements by using relative humidity sensors. It is to be noted that even though the existing signal marker database accounts for a maximum of 0.65 mol fraction of water, this database has been extrapolated to quantify mole fraction as high as 1.0. The validity for this extrapolation stems from the strong linear correlation between the normalized ratio of the signal intensity and the concentration of water.

In summary, a plasma based optical emission spectroscopy technique has been developed for detecting and quantifying water vapor concentration in moisture enriched flow conditions. The normalized fractional intensity of H was identified to have a strong linear dependency on the water vapor content in the gas stream and therefore was selected as a detection and quantification marker. It was further found that the normalized intensity was independent of the plasma discharge current conditions in the “normal glow” regime of operation of the discharge as well as the vacuum operating pressure. The proposed methodology has been applied to effectively characterize outflow gases from vacuum drying of a mock nuclear used fuel assembly.

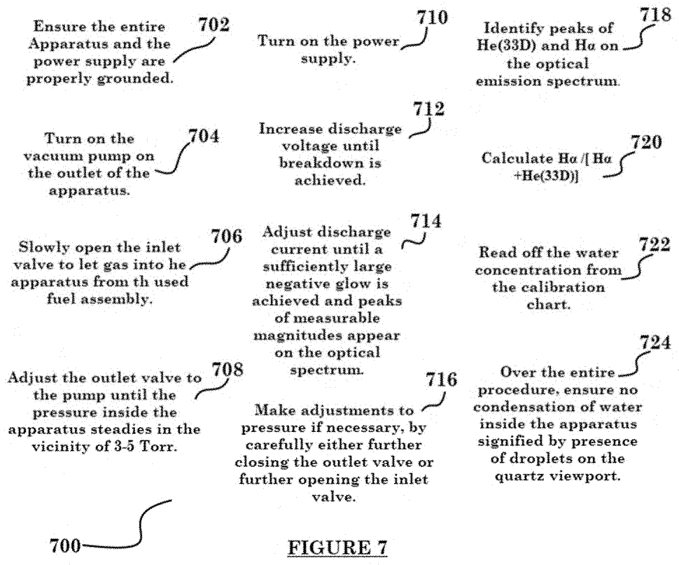

In a further embodiment, see FIG. 7, step-by-step instructions 700 for operation of a system of the current disclosure include: (1) at step 702, ensure the entire apparatus and the power supply are properly grounded; (2) at step 704, turn on the vacuum pump on the outlet of the apparatus; (3) at step 706, slowly open the inlet valve to let gas into the apparatus from the used fuel assembly; (4) a step 708, adjust the outlet valve to the pump until the pressure inside the apparatus steadies in the vicinity of 3-5 Torr; (5) at step 710, turn on the power supply; (6) at step 712, increase discharge voltage until breakdown is achieved; (7) at step 714, adjust discharge current until a sufficiently large negative glow is achieved and peaks of measurable magnitudes appear on the optical emission spectrum; (8) at step 716, make adjustments to pressure if necessary, by carefully either further closing the outlet valve or further opening the inlet valve; (9) at step 718, identify peaks of He(33D) and Ha on the optical emission spectrum; (10) at step 720, calculate Hα/[Hα+He(33D)]; (11) at step 722, read off the water concentration from the calibration chart; and (12) at step 724, for the entire operation, ensure that there is no condensation of water inside the apparatus signified by presence of droplets on the quartz viewport.

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art using the teachings disclosed herein.

What is claimed is:

1. A plasma discharge cell water vapor detection system comprising:
an inlet feedthrough;
an outlet feedthrough;
a plasma cell including at least two electrodes forming an inter-electrode gap;
an optical emission spectrometer including at least one optical filter;
a chamber containing at least the at least one electrode and the optical emission spectrometer;
a cathode;
an anode; and
at least one flange.

2. The plasma discharge cell water vapor detection system of claim 1 wherein the at least one electrode is formed from copper.

3. The plasma discharge cell water vapor detection system of claim 1 including at least two electrodes having an insulation coating on an outer periphery of the at least two electrodes excluding insulation at an end of each electrode that forms an inter-electrode gap between the at least two electrodes.

4. The plasma discharge cell water vapor detection system of claim 1 wherein the chamber comprises a four-way cross chamber.

5. The plasma discharge cell water vapor detection system of claim 1 wherein at least one flange comprises a visualization port.

6. The plasma discharge cell water vapor detection system of claim 1 wherein the system is insensitive to any type of radiation effect from a spent nuclear fuel rod.

7. The plasma discharge cell water vapor detection system of claim 1 wherein the system is installed in a spent nuclear fuel cask.

8. The plasma discharge cell water vapor detection system of claim 1 wherein the system has an inter-electrode separation distance capable of being increased or decreased.

9. A method for quantifying water vapor concentration in a gaseous stream comprising:
forming a negative pressure via a vacuum pump inside a plasma chamber;
injecting a sample into a vacuum chamber thereby mixing the sample with a carrier gas;
flowing the mixed carrier gas mixed with sample past at least one mass flow controller;
initiating and maintaining a plasma discharge;
measuring a voltage across the plasma discharge and across a shunt via a cathode ray oscilloscope and a high voltage probe;
detecting water vapor concentration via measuring hydrogen emissions undergoing a first series Balmer transition; and
quantifying the water vapor concentration in the carrier gas and sample mixture.

10. The method for quantifying water vapor concentration in a gaseous stream of claim 9 wherein the carrier gas is helium.

11. The method for quantifying water vapor concentration in a gaseous stream of claim 9 wherein H_{α} emission is measured

12. The method for quantifying water vapor concentration in a gaseous stream of claim 9 wherein the plasma discharge is operated in normal glow mode so that the plasma discharge maintains a constant electron, ion, and excited state number density value.

13. The method for quantifying water vapor concentration in a gaseous stream of claim 9 wherein the hydrogen emission measure is Ha at 656.2 nm.

14. The method for quantifying water vapor concentration in a gaseous stream of claim 9 wherein the method is insensitive to any type of radiation effect from a spent nuclear fuel rod.

15. The method for quantifying water vapor concentration in a gaseous stream of claim 9 wherein the method is employed with respect to a spent nuclear fuel cask.

16. The method for quantifying water vapor concentration in a gaseous stream of claim 9 further comprising varying an inter-electrode separation distance.

17. A method for operating a plasma discharge cell water vapor detection system comprising:
ensuring the system and a power supply are properly grounded;
activating a vacuum pump on an outlet of the system;
opening an inlet valve to let gas into the system apparatus from a sample;
adjusting an outlet valve to the vacuum pump until pressure inside the system reaches approximately 3-5 Torr;
activating the power supply;
increasing discharge voltage until breakdown is achieved;
adjusting a discharge current until a sufficiently large negative glow is achieved and peaks of measurable magnitudes appear on an optical emission spectrum;
identify emission peaks via an optical emission spectrum;
calculate emission presence; and
over a course of operation for the system, ensure there is no condensation of water inside the system.

18. The method of claim 17 further comprising adjusting pressure by either further closing the outlet valve or further opening the inlet valve.

19. The method of claim 17 further comprising comparing the emission peaks to a water concentration calibration chart.

20. The method of claim 17 further comprising wherein condensation is signified by presence of droplets on a viewport.
